(19) United States
(12) Patent Application Publication
(10) Pub. No.: US 2007/0250837 A1
(43) Pub. Date: Oct. 25, 2007

(54) System and method for adjusting multiple resources across multiple workloads

(76) Inventors: Daniel E. Herington, Fort Collins, CO (US); Isom L. Crawford JR., Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/409,814

(22) Filed: Apr. 24, 2006

(51) Int. Cl. G06F 9/46

(52) U.S. Cl. 718/105

(57) ABSTRACT

Increased workload performance is obtained by coordinating a multi-resource computer system such that demands for resources are arbitrated across all available resources and all applications such that the proper resource will be adjusted regardless of which resource is needed to improve workload performance. In operation, a measurement is taken for each available resource to determine the enhancement achieved by adding a certain quantity of a resource. In one embodiment, resource consumption and performance data is collected over a period of time and that data is used to adjust resource requests for a workload in order to improve the workload's performance. The resource request is modified to deliver the most workload benefit for each resource modification.

### FIELD OF THE INVENTION

This disclosure relates to computer systems and more particularly to systems and methods for computer workload management.

### DESCRIPTION OF RELATED ART

Currently, computer goal-based workload management systems operate to adjust the CPU in response to an arbitrary measure of performance for any arbitrary workload. The key problem with this is that if a workload is not CPU intensive, the adjustment of CPU may not improve the performance of the workload.

One option is to simply use resource utilization to adjust multiple resources. One problem with this approach is that it may waste resources because some applications may receive performance that far exceeds the requirements for the application. This problem is compounded in that workloads may react differently to the availability of different resources and an adjustment solution must work for any arbitrary workload and it must work for any measure of performance for that workload.

Another issue is that a workload's performance may be impacted by resource contention caused by other workloads. Such contention can cause resource requirements to vary over time based on what the application is doing at the time and on the other applications that are running on the system at that time and what stage such application is in.

In some arrangements, a computer system workload is affected by the amount and type of resources that are available to the workload at any particular time. Thus, when a workload is underperforming it is desirable to adjust the resources that are available to it.

Current systems address a single resource and, hence, require separate resource allocation policies for each computer system resource that can be adjusted. These “single” resource management systems add complexity to defining a resource allocation policy for workload management systems.

Workload management is the approach of adjusting resource entitlements (such as the number of CPUs, the amount of memory, etc.) to workloads based on workload performance data. When multiple resources are being adjusted it is difficult to determine which resource to adjust to achieve optimum results. It is also difficult to know how much a given resource change will improve the performance of the workload.

As an example, if a system is measuring the response time of a workload and it has the ability to adjust the entitlements of, for example, CPU, memory, disk I/O bandwidth or network bandwidth, how does it know which of these should be adjusted to improve the response time of the workload?

### BRIEF SUMMARY OF THE INVENTION

There are disclosed systems and methods for coordinating a multi-resource computer system such that demands for resources are arbitrated across all available resources and all applications such that the proper resource will be adjusted to increase the proper workload performance regardless of which resource is needed to improve workload performance. In one embodiment, the system tracks performance data across all resources so that the system knows for all resources what to expect from a resource adjustment at any point in time. Using the system and methods disclosed, any desired resource adjustment is tempered to insure that maximum benefit is derived from such an adjustment. Arbitration is used to mediate between competing resource requests.

In one embodiment, resource allocation vectors are used to determine allocation of resources that will improve a workload's performance. In operation, a measurement is taken for each available resource to determine the enhancement achieved by adding a certain quantity of a resource. In this manner a historical profile is created for a point in time dependant upon the workload's actual response at that time to changes in resource availability. When the performance of a workload requires enhancing by the adjustment of a resource, the historical profile is used as a vector by the workload policy controller to adjust resource to achieve the desired enhanced performance.

In one embodiment, resource consumption and performance data is collected over a period of time and that data is used to adjust resource requests for a workload in order to improve the workload's performance. The resource request is modified to deliver the most workload benefit for each resource modification.

### BRIEF DESCRIPTION OF THE DRAWINGS

For a more complete understanding of the present invention, reference is now made to the following descriptions taken in conjunction with the accompanying drawings, in which:

FIG. 1 shows one embodiment of a system having multiple resources available to a plurality of workloads;

FIG. 2 shows one embodiment of a system for adjusting multiple resources for multiple applications;

FIG. 3 shows one embodiment of a computer system having multiple resource capabilities; and

FIG. 4 shows one embodiment of a process for controlling workload resource allocation.

### DETAILED DESCRIPTION

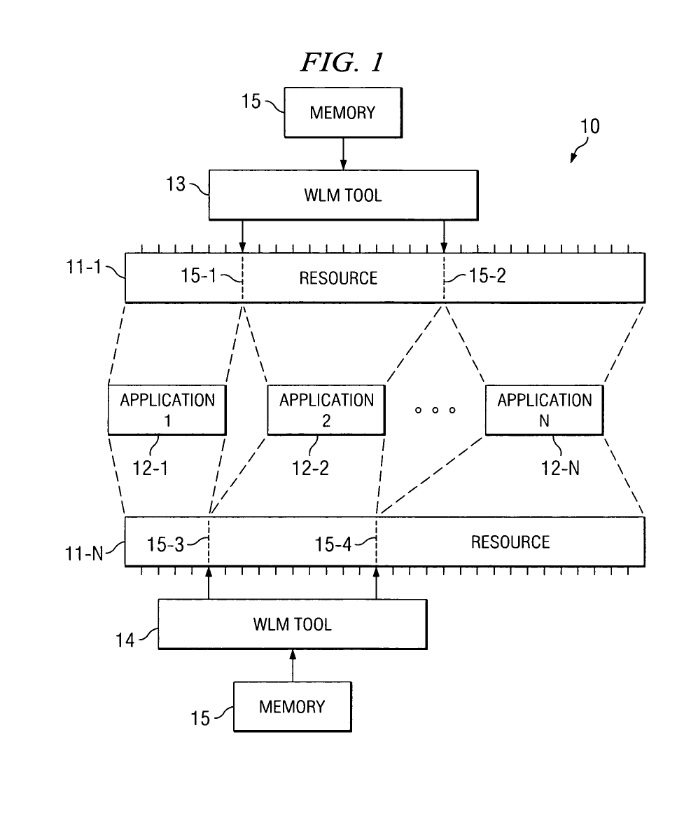

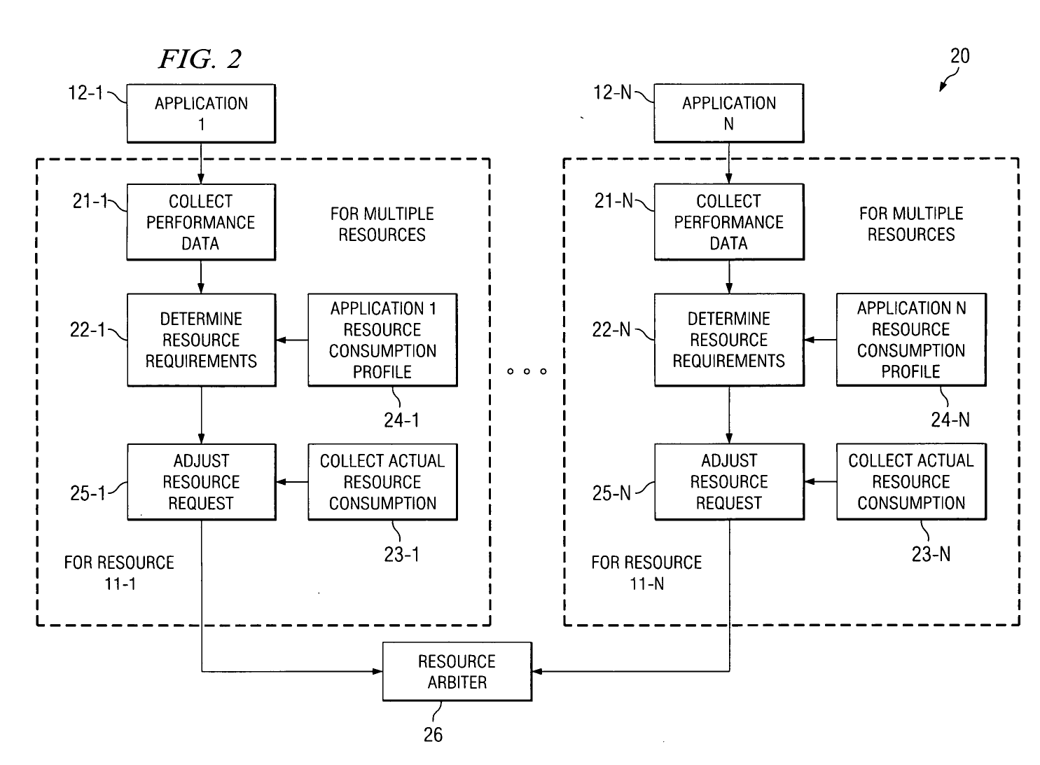

FIG. 1 shows one embodiment 10 of a multi-resource (11-1 to 11-N) computer system serving workloads (applications) 12-1 to 12-N. The resources are managed by workload management (WLM) tools 13 and 14, working from input from adjust resource request 25-1 (FIG. 2). Each WLM adjusts the amount of each resource required by application 1 or by any other application. FIG. 1 shows two resources, 11-1 and 11-N, which typically would be memory and CPU, but could be any resource(s), such as bandwidth, network, I/O bandwidth, kernel data structure space, process table entries, etc.

WLM tools 13 and 14 are most likely a single instance of WLM and, as will be seen, operate to change the partitions 15-1 to 15-4 for each resource for each application as necessary.

The structure shown in FIG. 2 is one embodiment of a system for adjusting multiple resources for a single application.

FIG. 2 shows one embodiment 20 of a system and method for adjusting multiple resources 11-1 to 11-N for multiple applications 12-1 to 12-N. Embodiment 20 can, if desired, be part of WLM 13, 14 or could be stand-alone on part of controller. The discussion of FIG. 2 addresses only a single resource for each application, but multiple resources are considered for each application.

For discussion purposes, let us assume that resource 11-1 is memory monitored by WLM tool 13 (FIG. 1) and that resource 11-N is CPU monitored by WLM tool 14 (FIG. 1). The process starts with the collection of performance metrics by process 21-1 for application 1 as that application is running on the system. The collected data is then compared to the determined resource requirements by process 22-1 operating in conjunction with application 1 resource consumption profile 24-1. Consumption profile 24-1 operates to add the proper measure of the resource based as calculated gain the most performance from the workload (application).

Resource requirements can be based on a basic or sophisticated profile based controller algorithm. The resources that a workload (application) has available to it depends upon the workload's utilization of those resources. For example, if the workload is entitled to use 60 shares of CPU and is using 40, that is a 66% utilization of CPU. If the same workload has access to 2 Gigabytes of memory (not shown) and is using 1.5 Gigabytes, that is 75% utilization. If it has access to 2 Gigabytes/sec of network bandwidth and is using 1.9 Gigabytes, that is 95% utilization. A resource manager seeing that utilization is over a certain threshold level might then call for additional resources.

It would be easy to look at these resource requests and assume that because network bandwidth is at 95% utilization the problem is with network capacity. This may or may not be a factor in slower than expected workload processing by calculating individual resource pressure. The system can, based upon a knowledge of how each resource impacts workload performance, adjust a resource request based on the likelihood that the request resource will actually help improve the performance workload. As an example, memory can be at 95% utilization. Adding memory will have no impact on performance since the workload's total data is already in memory. This is in contrast to the CPU rising above 80%, as it starts impacting performance due to process context switching being performed continuously. The time for such processing becomes excessive when CPU utilization goes above 80%.

Based upon the input from process 22-1 and input from process 23-1 which collects the actual resource consumption by application 1, process 25-1 issues commands for adjusting resource requests. These commands are sent to the proper WLM tool (in this case tool 13) to change the partition (15-1, FIG. 1) for resource 11-1. Process 25-1 can, if desired, examine resource performance patterns which reflect knowledge about how a particular resource impacts the performance of a workload this knowledge could be put into the system by a system user, but most typically would be gathered over time and stored, for example, in memory 15 (FIG. 1). The purpose of this operation is to understand how adding (or removing) resources helps, does nothing or possibly hinders performance. Thus, as discussed above, a request for additional memory may not be the solution to a performance problem even if the memory is at 95% utilization.

Process 25-1 adjusts the resource requests (for all resources for application 1) based on the utilization of the same resource in the prior interval and the pattern of how these resources impact performance and sends these requests to resource arbiter 26. This can be done serially on a resource by resource basis, or all at one time, as desired.

Thus, process for resource 11-N (and for any other resource) is the same as for resource 11-1, except performed by processes 21-N through 25-N. Note that while the processes for resources 11-N are shown separately from the processes for resource 11-1, they, in fact could be the same. Also note that while separate processes 21-1 to 25-1 are shown, they could also be a single process or any combination thereof.

The process for application 12-N (and for any other application) is the same as application 12-1, which is performed by processes 21-N through 25-N, such that adjust source request 25-N sends requests for all needed resources (with respect to application N-1) to arbiter 26. Arbiter 26 then determines the mediation between resources and between applications to maximize the overall system operation. Arbiter 26 can work on all resources or on one at a time, as desired.

Note that while the processes for applications 12-N are shown separately from the processes for applications 12-1, they, in fact could be the same and used serially. Also note that while separate processes 21-1 to 25-1 are shown, they could also be a single process or any combination thereof.

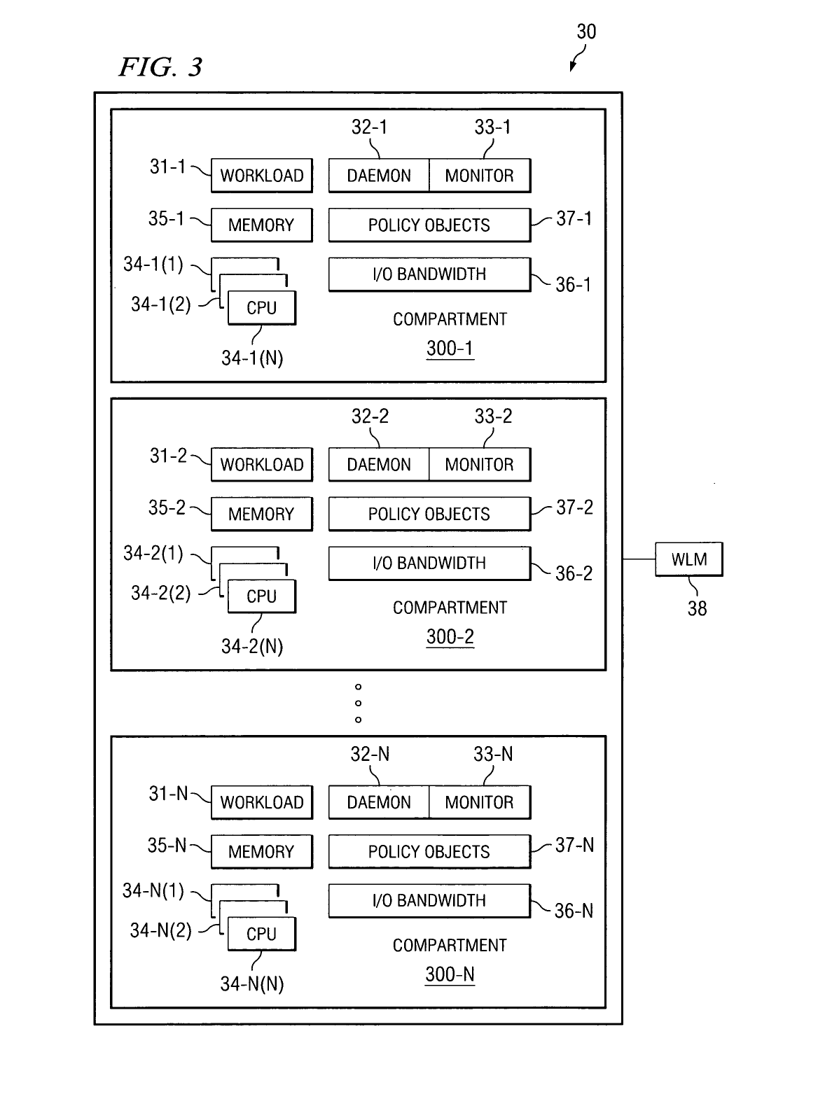

FIG. 3 shows one embodiment 30 of computer system 310 having multiple resource capabilities which resources can be used as needed to increase (or decrease) a workload's performance. In the embodiment of FIG. 3 workload 31-1 can use CPUs 34-1 to 34-N and memory 35-1 and I/O bandwidth 36-1 to 36-N. Particular workload, such as workload 31, typically has a single dimensional value (e.g., database transaction time) that is used to monitor performance. However, the workload's performance is a function of the allocation of multiple computer system resources (e.g., CPU, memory, I/O, etc.). The response to increasing one resource over another resource may be dramatically different. For example, some applications may not benefit at all from an increase in CPU resources, but instead may improve dramatically to increases in say, memory allocation.

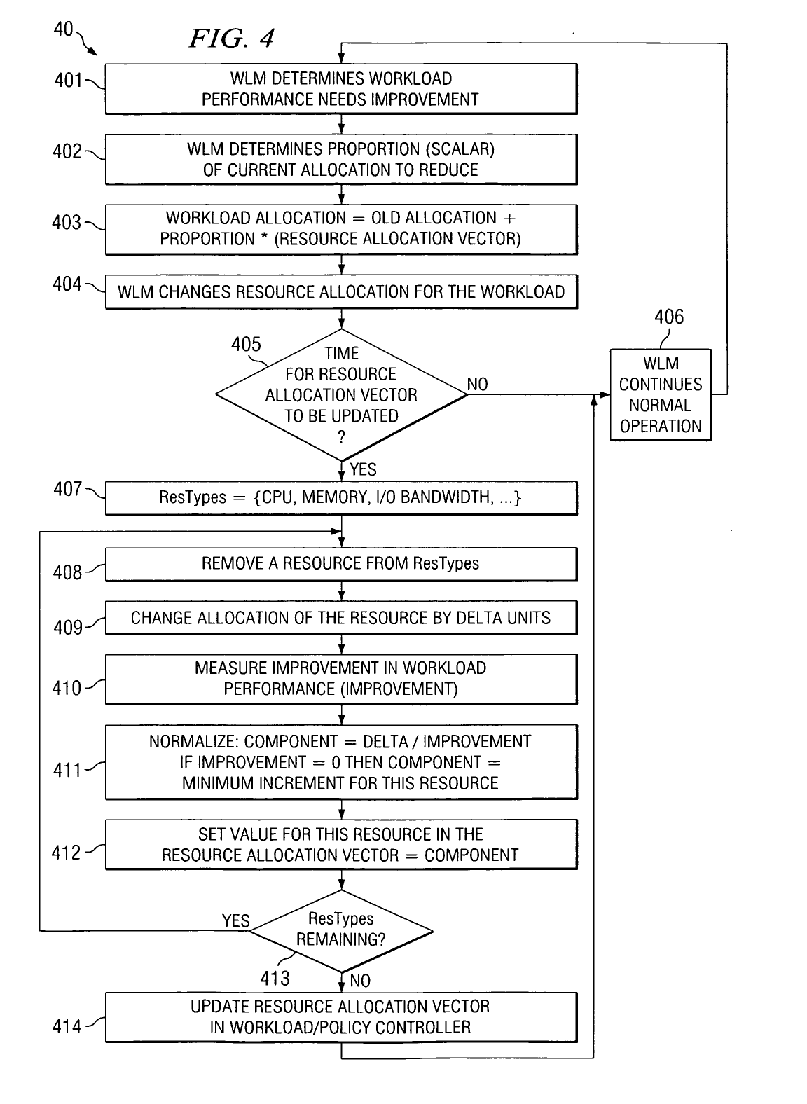

Workload manager (WLM) 48, working with policy objects 47-1 to 47-N control the resource allocation in conjunction with process 40, as will be discussed with respect to FIG. 4.

FIG. 4 shows one embodiment 40 of a process for controlling workload resource allocations such that process 401 in conjunction with WLM determines that a particular workload performance needs improvement.

In process 402 the WLM determines the proportion (scalar) of the current allocation to reduce by using a previously calculated resource allocation vector (as will be discussed hereinafter). Process 403 calculates the workload allocation to equal the old allocation plus the proportion (resource allocation vector) to reduce or add the needed resources. Process 404 changes the resource allocation for the workload under control of the WLM.

Note that as discussed above, processes 401 through 404 operate on the assumption that an allocation vector has previously been established for the next change to occur. If it is time for reestablishing an updated resource allocation vector, process 405 initiates process 407 which determines the resource type, i.e., CPU memory input/output, bandwidth, etc.

Process 408 removes the target resource to be updated from the list of resource types available. Process 409 changes the allocation of the resource by delta units. Process 410 takes a measurement of the improvement in the workload performance; this is the improvement.

Process 411 then normalizes the scalar by determining that the component equals the delta divided by the improvement. If the improvement is zero, then the component equals the minimum increment for this resource. This means that if there has been no improvement by increasing the resource there is no need to continue to change the resource.

Process 407 then begins a process of iterations such that a different resource component is tested and if there are more resource types to be tested remaining then processes 408, 409, 410 and 411 continue. When all resource types have been tested, process 414 updates each resource allocation factor in the workload policy controller which is part of the WLM.

Note that with processes 407, 408, 409, 410, 411 and 412, each resource in turn is tested to determine what effect a change in that resource will have on the operation (performance) of the workload. Subsequently, this resource allocation vector is used in process 403. This is done after process 402 in which WLM determines the magnitude (proportion) of the change in resource allocation needed by the workload. These settings are then maintained in WLM and used in processes 402, 403 and 404 to set the resource to the proper level when an adjustment in resources is necessary. Thus, in process 401 when the determination is made that a workload performance needs improvement, process 402 looks in its allocation of scalars and determines which scalars to apply to which resources and the resource is adjusted. From prior iterations it was known that a certain adjustment will result in a certain increase and so as a result when a resource is added it is highly likely that performance will be enhanced. Process 406 continues monitoring resource allocation that no updates are taking place.

As discussed above, the initial unit of resource allocation is not critical, since it is the vector that determines which resource should be adjusted and by how much. The system effectively uses pre-profiling of each resource response to a particular workload after a certain period of time, or whenever a given resource allocation reaches its maximum (or minimum), the allocation vector is recalculated directly, as a moving average, or as a smoothed combination of previous vectors.

Thus, as discussed, multiple computer system resources are considered when allocating resources to a workload so that the workload can meet its performance criteria. The systems and methods discussed herein make resource allocation policy definition easier by allowing for a single specification for multiple computer system resources, based on an historical response of the workload to changes in each individual resource allocation to the workload.

As discussed, process 40 can run, if desired, in a global controller (not shown) or in one or more of the resource managers. Process 401 collects resource consumption data by extracting data from the system on a resource by resource basis to determine how much of each resource was consumed by the workload in the prior interval. This data can come from the resource managers or from other sources and can be stored in storage (not shown) if desired.

Process 40 makes it possible to adjust multiple resource entitlements simultaneously and have a reasonable likelihood of making appropriate adjustments that will improve the response time of the workload, without wasting resources that are not likely to improve performance.

What is claimed is:

1. A method of operating a multi-resource, multi-workload computer, said method comprising:
gathering data on resource availability;
gathering data on workload performance on a per workload basis; and
adjusting resource requests for each workload based upon said gathered resource availability and gathered workload performance data.

2. The method of claim 1 wherein said adjusting comprises:
arbitrating among resource requests across all workloads.

3. The method of claim 1 wherein said adjusting comprises:
selecting the proper amount of a resource to adjust.

4. A method of managing performance in a multi-workload, multi-resource computer system, said method comprising:
collecting resource consumption and performance data on each resource available in said computer system, said data collected on an individual workload basis;
accepting incoming resource requests for a particular resource for enhancing the performance of a particular workload; and
adjusting said resource request based upon said collected resource consumption and performance data.

5. The method of claim 4 wherein said adjusting comprises:
selecting the proper resource to adjust.

6. The method of claim 4 wherein said adjusting comprises:
selecting the proper amount of a resource to adjust.

7. The method of claim 4 wherein said adjusting further comprises:
arbitrating among competing resource requests.

8. A computer system comprising:
a plurality of resources available for use by a plurality of workloads;
means for collecting resource consumption data pertaining to the utilization of resources across workloads;
means for collecting resource performance patterns;
means for accepting requests for resource modifications for a particular workload; and
means for adjusting any said received request based upon said collected resource consumption data and said collected resource performance patterns.

9. The computer system of claim 8 further comprising:
means for arbitrating across workloads for competing resource requests.

10. The computer system of claim 9 further comprising:
a controller operating across a plurality of said workloads for controlling said resource adjustments.

11. A computer system comprising:
a workload manager for controlling multiple resource allocations to different workloads running on said computer, said manager comprising:
memory for storing therein resource consumption data on a resource by resource basis and resource performance data on a resource by resource basis; and
control for adjusting resource requests for each workload based upon said stored consumption and performance data.

12. The computer system of claim 11 further comprising:
an arbiter for arbitrating adjustments between competing resource requests.

13. The computer system of claim 12 wherein said control comprises:
a process for observing performance results by changing one or more of a plurality of available resources on a particular workload; and
means for repeating said observing for each available resource.

14. The computer system of claim 13 further comprising:
a process for selecting based on said stored profiles which resource should be adjusted at any particular time.

15. The computer system of claim 12 wherein said resource arbitration is across workloads as well as resources.

16. A computer program product having computer readable media, said media comprising:
code for controlling the gathering of data on resource availability;
code for controlling the gathering of data on resource performance; and
code for controlling the adjustment of resource requests based upon said gathered resource availability and gathered resource performance data.

17. The computer program product of claim 16 wherein said code for controlling the adjustment comprises:
code for controlling arbitration among resource requests.

18. The computer program product of claim 17 wherein said arbitration is across a plurality of servers.

19. The computer program product of claim 17 wherein said code for controlling the adjustment comprises:
code for controlling the selection of the proper resource to adjust.

20. The computer program product of claim 17 wherein said code for controlling the adjustment comprises:
code for controlling the selection of the proper amount of a resource to adjust.

21. A method for enhancing computer performance, said method comprising:
observing performance results by changing one of a plurality of available resources on a particular workload;
repeating said observing for each available resource; and
storing the results of said observing as a profile of each resource with respect to said workload, said stored results available for use in adjusting resources with respect to said workload when such adjusting becomes necessary.

22. The method of claim 21 further comprising:
selecting based on said stored profiles which resource should be adjusted at any particular time.

23. The method of claim 22 further comprising:
repeating said observing, repeating and storing from time to time.

24. A computer program product having computer readable media stored thereon, said computer readable media comprising:
code for controlling the determination for each available resource a degree of performance change occasioned by a change in said resource on a particular workload; and
code for controlling the selection, based on said determined degree of performance change for each said resource, which resource to be added when said particular workload requires additional performance.

25. The product of claim 24 wherein said computer readable media further comprises:
code for controlling the selection of the degree of change in said selected resource.

26. The product of claim 25 wherein said computer readable media further comprises:
code for controlling the repetition of said determining to arrive at a revised degree of performance change occasioned by a change in said resource on said particular workload.

27. A computer system comprising:
a plurality of resources available for use by workloads running on said computer system;
means for determining for each available resource a degree of performance change occasioned by a change in said resource on a particular workload running on said computer system; and
means operable based on said determining means for indicating to said workload manager which resource should be added when said particular workload requires additional performance.

28. The system of claim 27 further comprising:
means for determining when a particular workload requires additional resources.

29. The system of claim 27 further comprising:
means for repeating said determining to arrive at a revised degree of performance change occasioned by a change in said resource on said particular workload.

30. The system of claim 29 further comprising:
means for selecting the degree of change in said selected resource.

31. A method for adjusting resources on a computer system, said method comprising:
determining that a workload needs performance improvement;
determining a proportional scalar to apply to a current resource allocation; and
changing the current resource allocation in accordance with said determined proportional scalar.

32. The method of claim 31 wherein said scalar determining comprises:
from time to time changing the allocation of a selected resource by a certain amount; and
measuring the result of said changing on workload performance.

33. The method of claim 32 further comprising:
normalizing said proportional scalar for said selected resource based on said measured result.

34. The method of claim 33 further comprising:
removing said changed allocation of said selected resource;
changing the allocation of a second selected resource by a certain amount;
measuring the result of said changing on workload performance; and
normalizing said proportional scalar for said second selected resource based on said measured result.

35. The method of claim 34 wherein said resources are spread among a plurality of partitions.

36. A computer system comprising:
a plurality of resources available to process a workload;
resource adjustment control for processing requests for resource adjustments to improve workload processing for said workload; and
a process for modifying any such processed requests for a particular resource adjustment such that only the resources calculated to deliver the most workload benefit from any such adjustment are modified.

37. The computer system of claim 36 wherein said resource adjustment control comprises:
a workload manager for controlling resource assignments to said workload running on said computer;
memory for storing therein resource consumption data and resource performance data; and
control for adjusting resource requests based upon said stored consumption and performance data.

38. The computer system of claim 37 further comprising:
a plurality of workloads sharing said resources.

39. A method for resource allocation in a multi-resource computer system, said method comprising:
determining for each available resource a degree of performance change occasioned by a change in said resource on a particular workload; and
selecting, based on said determined degree of performance change for each said resource, which resource to be added when said particular workload requires additional performance.

40. The method of claim 39 wherein said selecting further comprises:
selecting the degree of change in said selected resource.

41. The method of claim 40 further comprising:
repeating said determining to arrive at a revised degree of performance change occasioned by a change in said resource on said particular workload.

42. The method of claim 41 further comprising:
storing said performance change information in memory.

43. A computer system comprising:
a plurality of resources available for use by workloads running on said computer system;
a workload manager for determining for each available resource a degree of performance change occasioned by a change in said resource on a particular workload running on said computer system; and
wherein said workload manager is further operable based on said determining for indicating to said workload manager which resource should be adjusted when said particular workload requires additional performance.

44. The computer system of claim 43 wherein said workload manager is further operable for determining when a particular workload requires additional resources.

45. The computer system of claim 43 wherein said workload manager is further operable for repeating said determining to arrive at a revised degree of performance change occasioned by a change in said resource on said particular workload.

46. The computer system of claim 45 wherein said workload manager is further operable for selecting the degree of change in said selected resource.

47. The method for controlling resource adjustments with respect to a workload, said method comprising:
collecting performance data with respect to said workload;
determining the satisfaction level of said workload at a particular time;
demanding an adjustment in a resource for a particular workload; and
selecting which resource of a plurality of resources should be adjusted to obtain said workload's performance goals.

48. The method of claim 47 further comprising:
determining the magnitude of said selected resource adjustment.

49. The method of claim 48 wherein said determining comprises:
observing performance results by changing one of a plurality of resources available to said workload;
repeating said observing for each available resource;
storing the results of said observing as a profile of each resource with respect to said workload, said stored results available for use in adjusting resources with respect to said workload when such adjusting becomes necessary.

50. The method of claim 49 further comprising:
selecting, based on said stored profiles, which resource should be adjusted at any particular time.

51. The method of claim 49 further comprising:
repeating said observing, repeating and storing from time to time.

52. A computer program product having computer readable media stored thereon, said computer readable media comprising:
code for controlling the collection of performance data with respect to a workload;
code for controlling the determination of the satisfaction level of said workload at a particular time;
code for controlling an adjustment in a resource for said workload; and
code for controlling the selection of the resource from a plurality of resources that could be adjusted to obtain said workload's performance goals.

53. The computer program product of claim 52 further comprising:
code for controlling the determination of the magnitude that a selected resource should be adjusted.
